(19) United States
(12) Patent Application Publication
(10) Pub. No.: US 2026/0204449 A1
(43) Pub. Date: Jul. 16, 2026

(54) LIQUID XENON-POWERED NUCLEAR VOLTAIC SYSTEM UTILIZING RADIOACTIVE ISOTOPES

(71) Applicants: Nima Golsharifi, London (GB); Mohamed Abdelbaset Ahmed, Florence (IT)

(72) Inventors: Nima Golsharifi, London (GB); Mohamed Abdelbaset Ahmed, Florence (IT)

(21) Appl. No.: 19/557,231

(22) Filed: Mar. 5, 2026

(51) Int. Cl. G21H 1/12

(52) U.S. Cl. CPC G21H 1/12

(57) ABSTRACT

A nuclear voltaic power source utilizing liquid xenon as a high-density scintillation transducer medium combined with radioisotopes for electrical power generation. Liquid xenon, maintained at cryogenic temperatures between −111.75 and −108.1 degrees Celsius, has a density of approximately 2942 kg/m3, providing roughly 545 times the radiation interaction density of gaseous xenon. Ionizing radiation from the radioisotope interacts with liquid xenon to form Xe2 excimers that emit VUV photons at approximately 175 nm with a yield of 46 photons/keV. These photons are absorbed by wide bandgap semiconductor converters (diamond, AlN, SiC, GaN) lining the containment structure, generating electron-hole pairs extracted as electrical current. The spherical containment geometry maximizes photon capture. Cryogenic thermal management using vacuum-jacketed insulation or active cooling maintains the liquid phase. Multiple cells may be connected in series-parallel arrays for scalable power output.

### CROSS-REFERENCE TO RELATED APPLICATIONS

This application claims the benefit of priority to Singapore Patent Application No. 10202500578Y, filed Mar. 6, 2025, entitled “Liquid Xenon-Powered Nuclear Voltaic System Utilizing Radioactive Isotopes,” the entire disclosure of which is hereby incorporated by reference.

### FIELD OF THE INVENTION

The present invention relates to nuclear power generation, and more specifically to a nuclear voltaic power source that utilizes liquid xenon as a high-density scintillation transducer medium in combination with radioisotopes to convert nuclear radiation energy into electrical power. The liquid xenon converts radiation energy into vacuum ultraviolet photons through an excimer scintillation process, which are then absorbed by wide bandgap semiconductor converters to generate electrical current.

### BACKGROUND OF THE INVENTION

Traditional nuclear voltaic systems have relied primarily on solid-state materials, which present limitations in energy conversion efficiency, flexibility, and long-term stability under high-radiation environments. Gaseous xenon has been explored as a scintillation medium for radiation-to-photon conversion, but gaseous xenon at atmospheric pressure has a relatively low density of approximately 5.39 kg/m3, limiting the radiation interaction cross-section per unit volume.

Liquid xenon offers fundamental advantages over its gaseous form for nuclear voltaic applications. Liquid xenon has a density of approximately 2942 kg/m3 at its boiling point, representing a density increase of approximately 545 times compared to gaseous xenon at standard pressure. This dramatically increased density results in a correspondingly enhanced interaction cross-section between ionizing radiation and the xenon medium, producing significantly more scintillation photons per unit volume. The scintillation yield of liquid xenon is approximately 46 photons per keV of deposited energy, with emission centered at approximately 175 nm and fast decay times of 3 to 27 nanoseconds.

However, liquid xenon requires cryogenic temperatures for operation, with a melting point of approximately −111.75 degrees Celsius and a boiling point of approximately −108.1 degrees Celsius. The latent heat of evaporation is approximately 95.6 kJ/kg. The narrow liquid range of approximately 3.65 degrees Celsius necessitates precise thermal management to maintain the xenon in its liquid state. The present invention provides a system that addresses these cryogenic requirements while exploiting the superior scintillation density of liquid xenon for high-efficiency nuclear voltaic power generation.

### SUMMARY OF THE INVENTION

The present invention provides a nuclear voltaic power source comprising: (a) at least one radioisotope immersed in or positioned adjacent to liquid xenon; (b) liquid xenon as a high-density scintillation transducer medium maintained at cryogenic temperatures between approximately −111.75 and −108.1 degrees Celsius; (c) at least one wide bandgap semiconductor converter for absorbing the 175 nm VUV scintillation photons and converting them into electron-hole pairs; (d) electrical contacts for charge extraction; (e) a cryogenic containment structure with thermal management; and (f) radiation shielding.

The system exploits the approximately 545-fold density increase of liquid xenon over gaseous xenon to achieve correspondingly enhanced radiation-to-photon conversion per unit volume. The radioisotope may be immersed directly within the liquid xenon, providing intimate contact between the radiation source and the scintillation medium for maximum energy transfer efficiency.

### BRIEF DESCRIPTION OF THE DRAWINGS

FIG. 1 is a cross-sectional view of the spherical liquid xenon nuclear voltaic device showing the cryogenic containment, liquid xenon volume, radioisotope source, WBG semiconductor layer, and electrical contacts.

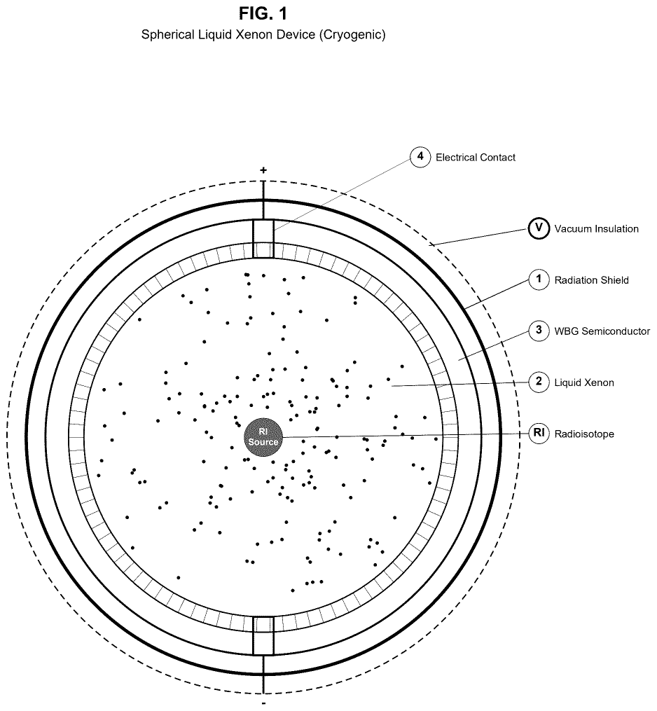

FIG. 2 is a detailed view of the scintillation conversion mechanism in liquid xenon.

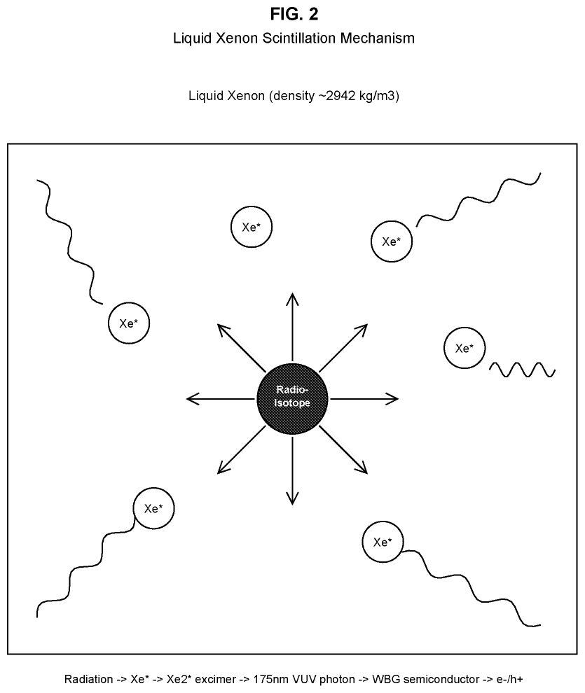

FIG. 3 is a vertical schematic of the three-stage energy conversion pathway.

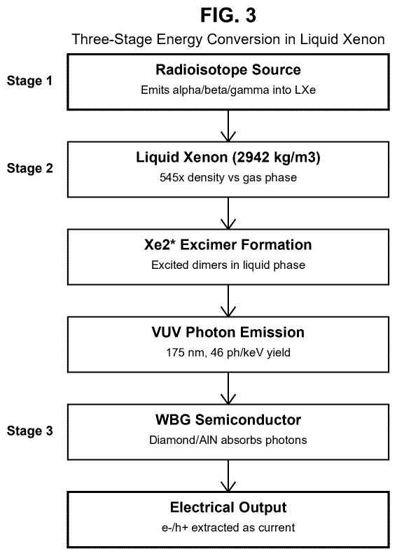

FIG. 4 is a table of liquid xenon physical and scintillation properties.

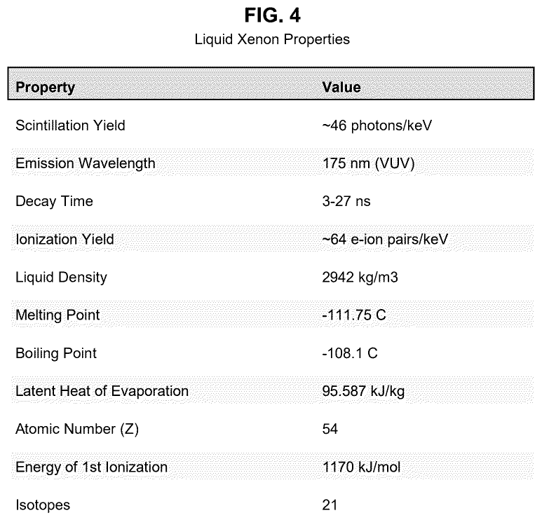

FIG. 5 is a comparison of liquid vs gaseous xenon density and stopping power.

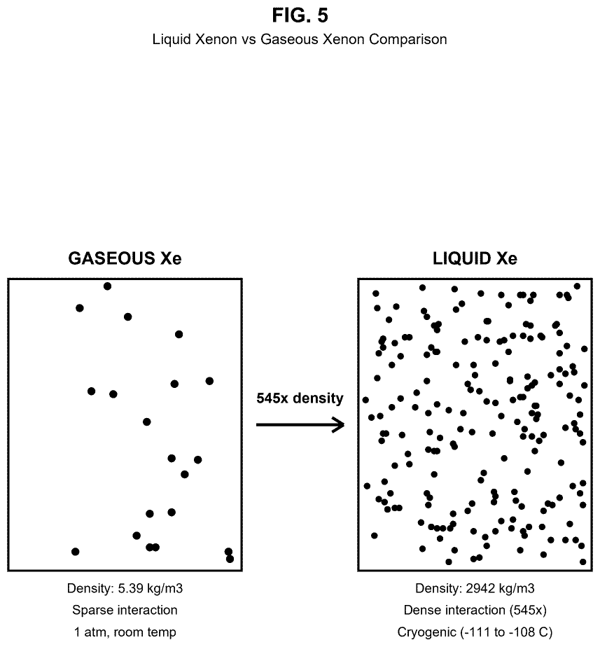

FIG. 6 is a cross-sectional view of a cylindrical configuration.

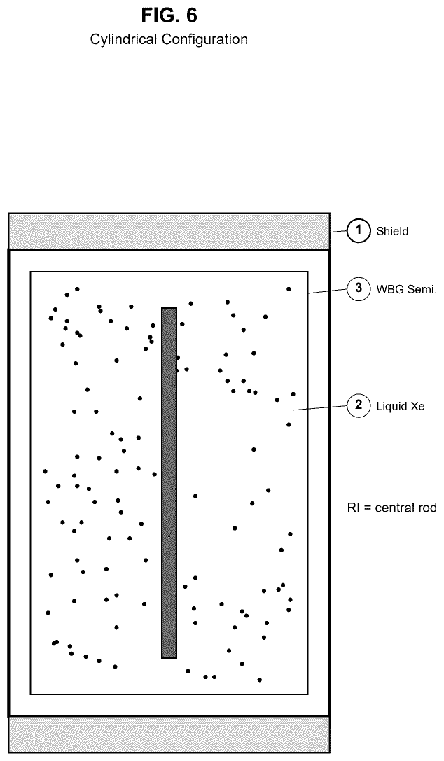

FIG. 7 is a cross-sectional view of a planar configuration.

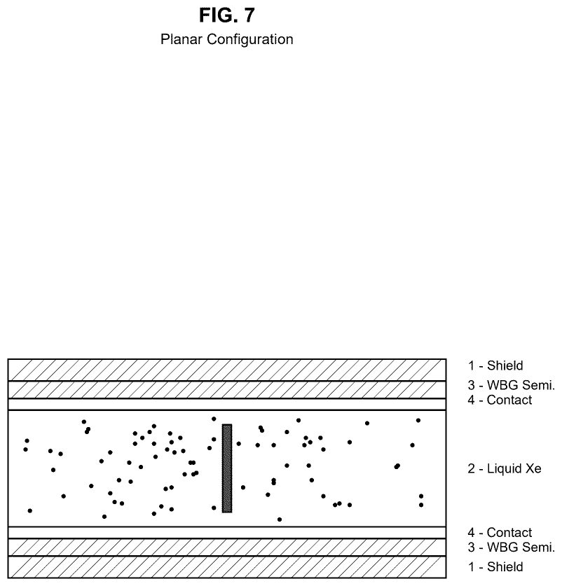

FIG. 8 is a parts reference table.

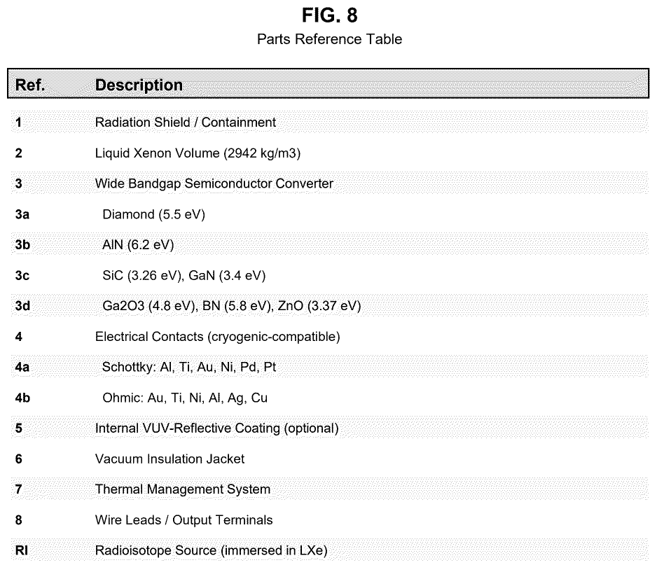

FIG. 9 is a thermal management schematic for cryogenic operation.

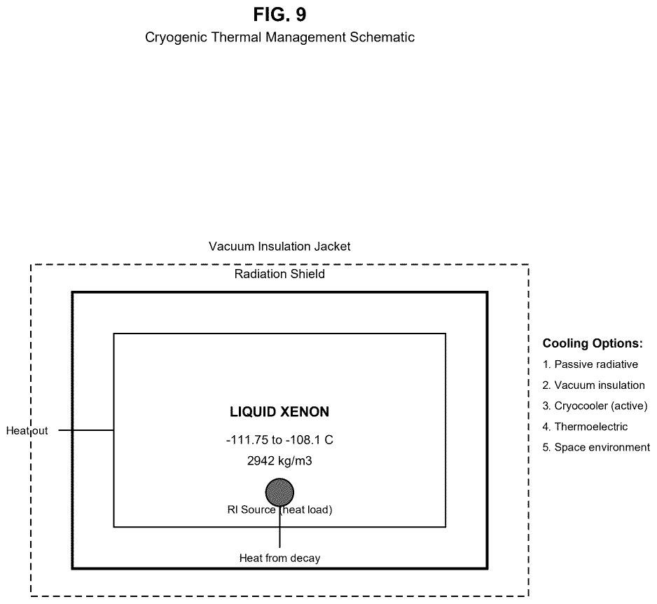

FIG. 10 is a series-parallel cell array schematic.

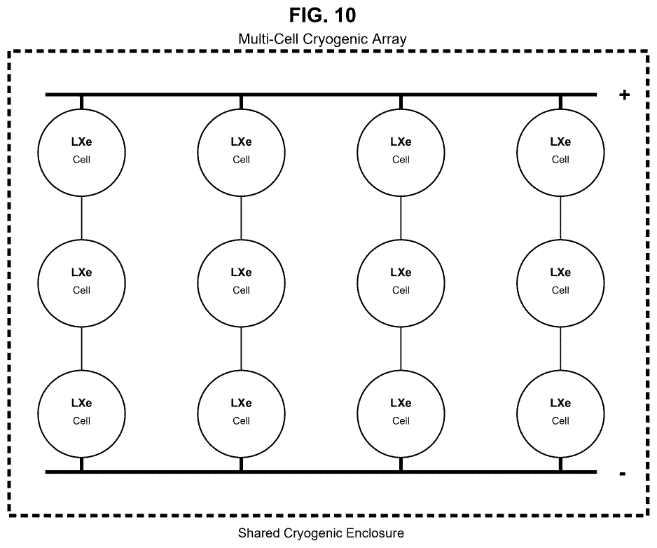

### DETAILED DESCRIPTION OF THE INVENTION

### Liquid Xenon Scintillation Medium

Liquid xenon serves as the primary scintillation transducer medium. When nuclear radiation such as alpha, beta, or gamma radiation interacts with liquid xenon, it excites xenon atoms and creates excited-state dimers known as Xe2 excimers. These excimers convert the deposited radiation energy into vacuum ultraviolet photons at approximately 175 nm as they relax to the repulsive ground state. The key properties of liquid xenon for this application include: scintillation yield of approximately 46 photons per keV, emission wavelength of approximately 175 nm, decay time of 3 to 27 nanoseconds, ionization yield of approximately 64 electron-ion pairs per keV, liquid density of approximately 2942 kg/m3, melting point of −111.75 degrees Celsius, boiling point of −108.1 degrees Celsius, and latent heat of evaporation of approximately 95.6 kJ/kg.

Compared to gaseous xenon at 1 atmosphere (density approximately 5.39 kg/m3), liquid xenon provides a density ratio of approximately 545:1. This means that for a given device volume, liquid xenon provides approximately 545 times the number of xenon atoms available for scintillation interaction, resulting in a proportionally higher radiation stopping power and photon production rate per unit volume.

### Radioisotope Source

The system utilizes at least one radioisotope selected from the group including, but not limited to: Ni-63, C-14, Pm-147, Am-241, Sr-90, P-32, Co-60, Cs-137, H-3, Po-210, Pu-238, Fe-55, V-48, Co-56, and combinations thereof. The radioisotope may be configured as a solid source immersed within the liquid xenon, as a source positioned adjacent to the liquid xenon with a thin window permitting radiation transmission, or as a dissolved or suspended material within the liquid xenon.

In a preferred embodiment, the radioisotope is provided as a solid source element positioned centrally within the liquid xenon volume, maximizing the solid angle of radiation emission captured by the surrounding liquid xenon. The source geometry may be configured as a rod, sphere, disc, or foil depending on the application requirements.

### Wide Bandgap Semiconductor Converter

The wide bandgap semiconductor converter is disposed to receive the 175 nm VUV photons produced by the liquid xenon scintillation. Suitable materials include: diamond (bandgap approximately 5.5 eV), aluminum nitride (AlN, bandgap approximately 6.2 eV), silicon carbide (SiC, bandgap approximately 3.26 eV), gallium nitride (GaN, bandgap approximately 3.4 eV), gallium oxide (Ga2O3, bandgap approximately 4.8 eV), boron nitride (BN, bandgap approximately 5.8 eV), and zinc oxide (ZnO, bandgap approximately 3.37 eV). Diamond and AlN are preferred for their wide bandgaps that more closely match the 7.08 eV photon energy, reducing thermalization losses.

### Electrical Contacts

Electrical contacts are provided for extracting photogenerated charge carriers. Schottky diode contacts may be formed from aluminum (4.28 eV), titanium (4.33 eV), gold (5.1 eV), nickel (5.15 eV), palladium (5.6 eV), or platinum (5.65 eV). Ohmic contacts may employ gold, titanium, nickel, aluminum, silver, or copper. Specialized contacts including ITO, graphene, molybdenum, tungsten, and chromium may be used for transparent or high-temperature applications. The contacts must be compatible with cryogenic operating temperatures.

### Cryogenic Containment and Thermal Management

The containment structure is designed as an insulated cryogenic vessel maintaining the xenon between −111.75 and −108.1 degrees Celsius. The vessel may incorporate vacuum-jacketed insulation, passive radiative cooling, or active refrigeration to maintain the liquid xenon temperature. The containment structure is preferably spherical to maximize photon capture angle by the wide bandgap semiconductor layer lining the interior.

The thermal management system accounts for the heat generated by radioisotope decay. For low-activity sources, passive cooling may be sufficient. For higher-activity sources, active cooling using a cryocooler or thermoelectric module may be required. In space applications, the cryogenic environment of outer space may be leveraged for passive thermal management.

### Device Configurations

The device may be configured in spherical, cylindrical, or planar geometries. In the spherical configuration, the wide bandgap semiconductor lines the interior of the sphere, the liquid xenon fills the interior, and the radioisotope source is positioned centrally. In the cylindrical configuration, the semiconductor lines the cylindrical wall with the radioisotope positioned along the central axis. An optional internal reflective coating may redirect unabsorbed VUV photons.

What is claimed is:

1. A nuclear voltaic power source comprising:
(a) at least one radioisotope configured to emit ionizing radiation;
(b) liquid xenon maintained at cryogenic temperatures as a scintillation transducer medium, the liquid xenon producing excimer scintillation photons at approximately 175 nm upon interaction with the ionizing radiation;
(c) at least one wide bandgap semiconductor converter disposed to receive the scintillation photons and convert them into electron-hole pairs;
(d) electrical contacts for extracting current from the wide bandgap semiconductor converter;
(e) a cryogenic containment structure maintaining the liquid xenon at a temperature between approximately −111.75 and −108.1 degrees Celsius; and
(f) radiation shielding surrounding the containment structure.

2. The nuclear voltaic power source of claim 1, wherein the liquid xenon has a density of approximately 2942 kg/m3 providing a density ratio of approximately 545:1 compared to gaseous xenon at standard atmospheric pressure.

3. The nuclear voltaic power source of claim 1, wherein the radioisotope is immersed directly within the liquid xenon, providing intimate contact between the radiation source and the scintillation medium.

4. The nuclear voltaic power source of claim 1, wherein the wide bandgap semiconductor converter is selected from the group consisting of diamond, aluminum nitride, silicon carbide, gallium nitride, gallium oxide, boron nitride, and zinc oxide.

5. The nuclear voltaic power source of claim 1, wherein the liquid xenon has a scintillation yield of approximately 46 photons per keV and an ionization yield of approximately 64 electron-ion pairs per keV.

6. The nuclear voltaic power source of claim 1, wherein the radioisotope is selected from the group consisting of Ni-63, C-14, Pm-147, Am-241, Sr-90, P-32, Co-60, Cs-137, H-3, Po-210, Pu-238, and Fe-55.

7. The nuclear voltaic power source of claim 1, wherein the cryogenic containment structure comprises vacuum-jacketed insulation.

8. The nuclear voltaic power source of claim 1, wherein the containment structure has a spherical geometry and the wide bandgap semiconductor converter lines the interior surface of the sphere.

9. The nuclear voltaic power source of claim 1, further comprising an internal reflective coating disposed on a portion of the containment structure interior to redirect unabsorbed scintillation photons toward the wide bandgap semiconductor converter.

10. The nuclear voltaic power source of claim 1, wherein the electrical contacts comprise cryogenic-compatible Schottky diode contacts formed from a metal selected from aluminum, titanium, gold, nickel, palladium, and platinum.

11. A method of converting nuclear radiation energy into electrical power using liquid xenon, the method comprising:
(a) maintaining xenon in a liquid state at a temperature between approximately −111.75 and −108.1 degrees Celsius within a cryogenic containment structure;
(b) exposing the liquid xenon to ionizing radiation from at least one radioisotope;
(c) generating excimer scintillation photons at approximately 175 nm within the liquid xenon;
(d) absorbing the scintillation photons in a wide bandgap semiconductor converter to generate electron-hole pairs; and
(e) extracting electrical current through electrical contacts on the wide bandgap semiconductor converter.

12. The method of claim 11, wherein step (b) comprises immersing a solid radioisotope source directly within the liquid xenon.

13. The method of claim 11, wherein step (a) further comprises managing thermal load from radioisotope decay using at least one of passive radiative cooling, vacuum-jacketed insulation, active cryocooling, and thermoelectric cooling.

14. The method of claim 11, wherein step (d) employs diamond or aluminum nitride as the wide bandgap semiconductor to minimize thermalization losses from the 7.08 eV scintillation photons.

15. The method of claim 11, further comprising reflecting unabsorbed scintillation photons back toward the wide bandgap semiconductor converter using an internal reflective coating.

16. A cryogenic liquid xenon nuclear voltaic power cell comprising:
a vacuum-insulated spherical containment vessel;
liquid xenon filling the interior of the spherical containment vessel at a temperature between −111.75 and −108.1 degrees Celsius;
a solid radioisotope source positioned centrally within the liquid xenon;
a wide bandgap semiconductor photovoltaic layer disposed on the interior surface of the spherical containment vessel;
electrical contacts on the wide bandgap semiconductor layer for extracting photogenerated current; and
a thermal management system configured to maintain the liquid xenon temperature within the liquid-phase range.

17. The cryogenic liquid xenon nuclear voltaic power cell of claim 16, wherein the wide bandgap semiconductor photovoltaic layer comprises diamond having a bandgap of approximately 5.5 eV.

18. The cryogenic liquid xenon nuclear voltaic power cell of claim 16, wherein the thermal management system comprises at least one of passive radiative cooling and active cryocooler.

19. The cryogenic liquid xenon nuclear voltaic power cell of claim 16, wherein the radioisotope source is configured as a rod, sphere, disc, or foil.

20. The cryogenic liquid xenon nuclear voltaic power cell of claim 16, further comprising a VUV-reflective coating on a portion of the interior surface not covered by the wide bandgap semiconductor.

21. A nuclear voltaic power source comprising:
a containment structure filled with liquid xenon having a density of approximately 2942 kg/m3;
at least one radioisotope immersed in the liquid xenon;
a wide bandgap semiconductor converter disposed within the containment structure to receive vacuum ultraviolet scintillation photons produced by xenon excimer formation resulting from interaction of ionizing radiation with the liquid xenon; and
electrical contacts for extracting photogenerated current from the wide bandgap semiconductor converter;
wherein the liquid xenon provides a radiation interaction density approximately 545 times greater than gaseous xenon at standard atmospheric pressure.

22. The nuclear voltaic power source of claim 21, wherein the wide bandgap semiconductor converter comprises diamond or aluminum nitride matched to the 175 nm emission wavelength.

23. The nuclear voltaic power source of claim 21, wherein the containment structure is spherical and the wide bandgap semiconductor converter lines the interior surface.

24. The nuclear voltaic power source of claim 21, further comprising a cryogenic thermal management system maintaining the liquid xenon at a temperature between −111.75 and −108.1 degrees Celsius.

25. The nuclear voltaic power source of claim 21, wherein the radioisotope is an alpha emitter positioned such that the alpha particle range is substantially contained within the liquid xenon volume.

26. A nuclear voltaic power system comprising:
a plurality of liquid xenon nuclear voltaic power cells, each cell comprising a cryogenic containment vessel filled with liquid xenon, at least one radioisotope, a wide bandgap semiconductor converter, and electrical contacts;
a shared or individual cryogenic thermal management system maintaining the liquid xenon in each cell at a temperature between −111.75 and −108.1 degrees Celsius; and
an electrical interconnection connecting the plurality of cells in at least one of a series and a parallel configuration to provide combined power output.

27. The nuclear voltaic power system of claim 26, wherein the plurality of cells share a common cryogenic enclosure and thermal management system.

28. The nuclear voltaic power system of claim 26, wherein the electrical contacts are cryogenic-compatible contacts comprising at least one of gold, platinum, and titanium.

29. The nuclear voltaic power system of claim 26, wherein each cell has a spherical geometry and the cells are arranged in a stacked array within the shared cryogenic enclosure.

30. The nuclear voltaic power system of claim 26, adapted for space applications wherein cryogenic temperatures are maintained at least in part by passive radiative cooling to the space environment.
